(19) United States
(12) Patent Application Publication
(10) Pub. No.: US 2025/0124352 A1
(43) Pub. Date: Apr. 17, 2025

(54) MACHINE LEARNING MODEL PROMPT DEMONSTRATION SELECTION

(71) Applicant: SRI International, Menlo Park, CA (US)

(72) Inventors: Anirudh Som, Plainsboro, NJ (US); Karan Sikka, Robbinsville, NJ (US); Ajay Divakaran, Monmouth Junction, NJ (US); Helen Gent, Urbana, IL (US); Andreas Kathol, El Cerrito, CA (US); Dimitra Vergyri, Sunnyvale, CA (US)

(21) Appl. No.: 18/916,442

(22) Filed: Oct. 15, 2024

Related U.S. Application Data
(60) Provisional application No. 63/596,184, filed on Nov. 3, 2023.

(30) Foreign Application Priority Data
Oct. 16, 2023 (GR) 20230100851

(51) Int. Cl. G06N 20/00

(52) U.S. Cl. CPC G06N 20/00

(57) ABSTRACT

Techniques are described for a machine learning system configured to generate respective sample embeddings for a plurality of sample statements. The machine learning system may further be configured to generate a statement embedding for a statement. The machine learning system may further be configured to determine, based on the sample embedding and the statement embedding, respective similarity scores for the sample embeddings. The machine learning system may further be configured to select, based on the respective similarity scores for the sample embeddings, one or more sample statements from the plurality of sample statements. The machine learning system may further be configured to generate a prompt including the one or more sample statements, the statement, and at least one of respective ground-truth information or respective paraphrases for the selected one or more sample statements. The machine learning system may further be configured to provide the prompt to a machine learning model.

### RELATED APPLICATIONS

This application claims the benefit of U.S. Patent Application No. 63/596,184, filed 3 Nov. 2023, and claims the benefit of Greece Patent Application Serial No. 20230100851, filed 16 Oct. 2023; each of which is incorporated by reference herein in its entirety.

### GOVERNMENT RIGHTS

This invention was made with government support under contract number HR001122C0032 awarded by Defense Advanced Research Projects Agency (DARPA). The Government has certain rights in the invention.

### TECHNICAL FIELD

This disclosure relates to machine learning systems and, more specifically, to generating prompts for machine learning models.

### BACKGROUND

Machine learning models may be configured to perform classification tasks and/or generative tasks. For example, machine learning models may be trained or augmented to include supervised generative models that are specifically trained to generate paraphrased statements based on large amounts of training data and iterative benchmarking. Training a machine learning model to perform specific tasks is a computationally expensive and time-consuming process.

### SUMMARY

In general, the disclosure describes techniques for selecting prompt demonstrations to prompt a machine learning model to perform a task such as statement classification or statement generation. An example computing system may generate embeddings for sample statements stored as reference data. Reference data may include sample statements paired with respective ground-truth labels such as ground-truth classification labels and/or ground-truth paraphrased statements. For example, a sample statement of reference data may include a sample statement labeled as offensive and/or paired with a corresponding paraphrased, inoffensive statement that maintains the intent of the sample statement but with more polite phrasing. The computing system may generate embeddings for each sample statement of reference data. For example, the computing system may generate an embedding for a sample statement that characterizes content of the sample statement in a high dimensional vector space. The computing system may store the embeddings for the sample statements of the reference data to use for generating an improved prompt for classifying a query or target statement and/or generating a paraphrased statement for the query or target statement.

During inference, the computing system may receive a target statement with a request to classify the target statement and/or generate a paraphrased statement for the target statement. The computing system may generate an embedding for the target statement that may, for example, characterize content of the target statement in the high dimensional vector space. The computing system may compare the embedding for the target statement to each embedding for the sample statements to determine a similarity score for each embedding for the sample statements. Based on the similarity scores for each sample embedding for the sample statements, the computing system may rank or order each sample statement. The computing system may select a set of demonstration sample statements (“demonstrations”) from among the sample statements based on the rank or order of the sample statements. For example, the computing system may select the set of demonstrations to include a predefined, specified, or determined number of sample statements associated with the best similarity score values (e.g., most similar), as well as respective ground-truth information such as classification labels for the number of sample statements and/or respective paraphrased statements for the number of sample statements.

The computing system may generate a prompt based on the set of demonstrations and the target statement. In some instances, the computing system may provide the prompt to a machine learning model (e.g., a large language model) to classify, based on sample statements and respective classification labels included for the set of demonstrations, the target statement by, for example, assigning a classification label to the target statement. In some examples, the computing system may provide the prompt to a machine learning model (e.g., a large language model) to generate, based on sample statements and respective paraphrased statements included for the set of demonstrations, a paraphrased statement for the target statement.

The techniques may provide one or more technical advantages that realize at least one practical application. For example, the computing system, according to the techniques described herein, may generate a prompt for a machine learning model based on sample statements that are similar to a target statement. Some system may generate a prompt for a machine learning model to include all of or a randomly selected set of sample statements of reference data in a prompt, which may result in a greater consumption of computational resources (e.g., processing cycles, memory usage, power usage, etc.) associated with a machine learning model processing each sample statement, as well as potentially lower performance of the machine learning model. Some systems may, additionally or alternatively, include additional heuristics or rules (e.g., considering diversity or complexity in selecting sample statements, fine-tuning or retraining a machine learning model to perform classification and/or paraphrasing of a statement, etc.) to improve the performance of a machine learning model classifying a target statement and/or generating a paraphrased statement. However, such systems implementing heuristics may result in increase in the utilization of computational resources (e.g., processing cycles, memory usage, power usage, etc.) with only a slight improvement in machine learning model performance. Such systems generally have a separate system specifically trained for statement classification and a separate system specifically trained for statement paraphrase generation, thereby resulting in added complexity and additional consumption of computational resources. By retrieving example demonstrations from reference data based on similarities of sample statements to a target statement, the computing system, according to the techniques described herein, may prompt a machine learning model (e.g., any type of transformer model) to accurately classify a target statement and generate a paraphrased statement for the target statement without having to retrain the machine learning model and without including an instruction in the prompt specifying a task for the machine learning model. In this way, the computing system may improve the efficiency and performance of classifications or paraphrases generated by a machine learning model without expending computational resources to implement complex heuristic approaches or training the machine learning model to perform specific tasks such as classifying a target statement or generating a paraphrased statement for a target statement.

In one example, a method includes generating, by a computing system, respective sample embeddings for a plurality of sample statements. The method may further include generating, by the computing system, a statement embedding for a statement. The method may further include determining, by the computing system, based on the sample embedding and the statement embedding, respective similarity scores for the sample embeddings. The method may further include selecting, by the computing system, based on the respective similarity scores for the sample embeddings, one or more sample statements from the plurality of sample statements. The method may further include generating, by the computing system, a prompt including the selected one or more sample statements, the statement, and at least one of respective ground-truth information or respective paraphrases for the selected one or more sample statements. The method may further include providing, by the computing system, the prompt to a machine learning model.

In another example, a computing system may include processing circuitry and memory for executing a machine learning system. The machine learning system may be configured to generate respective sample embeddings for a plurality of sample statements. The machine learning system may further be configured to generate a statement embedding for a statement. The machine learning system may further be configured to determine, based on the sample embedding and the statement embedding, respective similarity scores for the sample embeddings. The machine learning system may further be configured to select, based on the respective similarity scores for the sample embeddings, one or more sample statements from the plurality of sample statements. The machine learning system may further be configured to generate a prompt including the selected one or more sample statements, the statement, and at least one of respective ground-truth information or respective paraphrases for the selected one or more sample statements. The machine learning system may further be configured to provide the prompt to a machine learning model.

In another example, computer-readable storage media may include machine readable instructions for configuring a computing system to generate respective sample embeddings for a plurality of sample statements. The machine readable instructions may further configure the computing system to generate a statement embedding for a statement. The machine readable instructions may further configure the computing system to determine, based on the sample embedding and the statement embedding, respective similarity scores for the sample embeddings. The machine readable instructions may further configure the computing system to select, based on the respective similarity scores for the sample embeddings, one or more sample statements from the plurality of sample statements. The machine readable instructions may further configure the computing system to generate a prompt including the selected one or more sample statements, the statement, and at least one of respective ground-truth information or respective paraphrases for the selected one or more sample statements. The machine readable instructions may further configure the computing system to provide the prompt to a machine learning model.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating an example computing environment in which an example computing system generates prompts for in-context learning, in accordance with techniques of this disclosure.

FIG. 2 is a block diagram illustrating an example computing system with an example machine learning system configured to generate prompts for in-context learning, in accordance with techniques of this disclosure.

FIG. 3 is a conceptual diagram illustrating an example machine learning system for determining an example classification label for an example input statement, in accordance with techniques of this disclosure.

FIG. 4 is a conceptual diagram illustrating an example machine learning system for determining an example paraphrased statement for an example input statement, in accordance with techniques of this disclosure.

FIG. 5 is a conceptual diagram illustrating an example prompt for in-context learning, in accordance with techniques of this disclosure.

FIG. 6 is a table illustrating an example evaluation of in-context learning performance, in accordance with techniques of this disclosure.

FIG. 7 is a flowchart illustrating an example mode of operation for generating prompts for in-context learning, in accordance with techniques of this disclosure.

Like reference characters refer to like elements throughout the figures and description.

### DETAILED DESCRIPTION

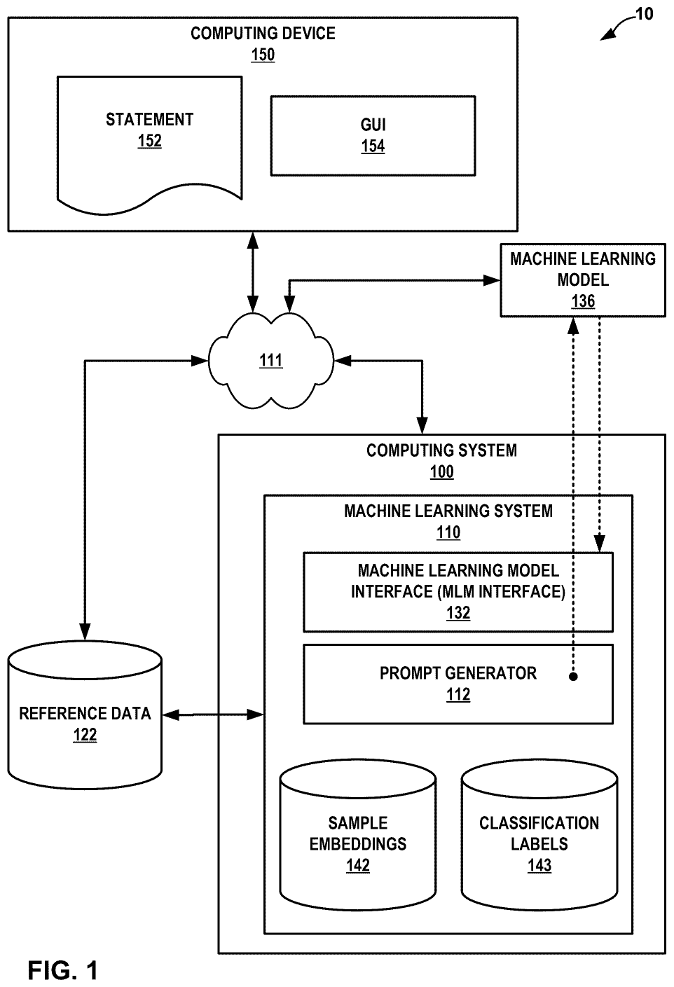

FIG. 1 is a block diagram illustrating example computing environment 10 in which example computing system 100 generates prompts for in-context learning (ICL), in accordance with techniques of this disclosure. Computing environment 10 includes computing system 100, computing device 150, reference data 122, and network 111. Computing device 150 may be a mobile computing device, such as a mobile phone (including a smartphone), a laptop computer, a virtual assistant, a voice assistant, a smart home device, a smart speaker, a smart display, smart watch, a smart television or set-top box or video/audio streaming device, a tablet computer, a gaming system, a wearable computing device, some combination of the above, or any other computing device. In the example of FIG. 1, computing device 150 stores statement 152 and graphical user interface (GUI) 154. Statement 152 may represent audio data, text data (e.g., string data structures), or other types of data representing an utterance, speech, text, or other type of statement created or otherwise input by a user associated with computing device 150. For example, statement 152 may represent audio data captured using a microphone of computing device 150 and/or audio data received by computing device 150 (e.g., via a tele-conferencing application). In another example, statement 152 may represent text data generated via user inputs associated with GUI 154 and/or text data received by computing device 150 (e.g., via a messaging application).

GUI 154 is a user interface that may be associated with functionality of computing device 150. For example, GUI 154 of FIG. 1 may be a user interface for a software application associated with a messaging application, a social media application, a word processing application, a tele-conferencing application, a video or audio streaming application, or the like. Computing device 150 may store statement 152 as audio data or text data input by a user interacting with GUI 154. For example, in instances where GUI 154 includes a user interface associated with a messaging application, computing device 150 may store statement 152 as user inputs associated with an electronic keyboard or external keyboard of computing device 150. In another example, in instances where GUI 154 includes a user interface associated with a tele-conferencing application, computing device 150 may store statement 152 as audio data associated with an utterance captured using a microphone of computing device 150. In some examples, computing device 150 may store statement 152 as text data by applying speech-to-text techniques to convert audio data captured using the microphone of computing device 150 to text data. In other examples, where statement 152 includes text data, computing device 150 may apply text-to-speech techniques to convert the text data of statement 152 to audio data prior to providing statement 152 to machine learning system 110. Although illustrated in FIG. 1 as internal to computing device 150, GUI 154 may generate output for display on an external display device. Although illustrated as external to computing system 100, computing device 150 may be a component of computing system 100. Computing device 150 may not include a GUI in all examples of computing device 150. For example, a voice assistant device implementation implements a voice interface to receive audio data as user input for statement 152.

Computing device 150 and computing system 100 may communicate via a communication channel, which may include network 111, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks or communication channels for transmitting data between computing systems, servers, and computing devices. In addition, computing system 100 may receive statement 152 from a storage device that interfaces with computing system 100 and that stores statement 152. Such storage devices may include a USB drive, a disk drive (e.g., solid state drive or hard drive), an optical disc, or other storage device or media.

Computing system 100 may represent one or more computing devices configured to execute machine learning system 110. Machine learning system 110 may include prompt generator 112, machine learning model interface 132 (also referred to herein as “MLM Interface 132”), sample embeddings 142, and classification labels 143. Prompt generator 112 may include computer-readable instructions for generating, based on a comparison of statement 152 to sample statements of reference data 122, a prompt for in-context learning. MLM interface 132 may include computer-readable instructions for interacting with machine learning model 136 (e.g., obtaining outputs of machine learning model 136) and/or managing machine learning tasks for machine learning system 110. MLM interface 132 may be configured to generate and output graphical data to an administrator of computing system 100 indicating outputs received from machine learning model 136 and/or operations of machine learning system 110 (e.g., data stored at classification labels 143, sample embeddings 142, reference data 122, etc.).

Although illustrated as external to computing system 100, reference data 122 may be a component of computing system 100, or more specifically machine learning system 110. Reference data 122 may represent a storage device configured to store entries of sample statements with respective ground-truth information. For example, reference data 122 may store sample statements as audio data representing an utterance of a statement, as a string data structure representing text of a statement, or in another form. Reference data 122 may store an entry of a sample statement with ground-truth information associated with a task machine learning system 110 may perform with respect to statement 152. For example, reference data 122 may store an entry including a sample statement with ground-truth information of a label classifying the sample statement (e.g., classification labels associated with toxicity of statements, classification labels associated with emotions conveyed in statements, etc.). In another example, reference data 122 may store an entry of a sample statement with a corresponding sample paraphrase associated with the sample statement (e.g., a paraphrased statement that is an inoffensive form of the sample statement, a paraphrased statement that is in a different emotional tone compared to the sample statement, etc.). Reference data 122 may include a variety of datasets developed using computing system 100 and/or obtained via network 111 (e.g., from the Internet). For example, reference data 122 may include a first sample dataset of APPDIA obtained from the Internet, a second dataset of ParaDetox obtained from the Internet, and a third sample dataset of Context-Aware Polite Paraphrases (CAPP) generated using computing system 100 that includes dialogue-style sample statements with context information associated with dialogue of the dialogue-style sample statements.

Although illustrated as external to computing system 100, machine learning model 136 may be a component of computing system 100, or more specifically machine learning system 110. Machine learning model 136 may represent one or more modules implementing artificial intelligence or other machine learning techniques. For example, machine learning model 136 may represent modules with machine readable instructions for executing one or more transformer models, such as Bidirectional and Auto-Regressive Transformers (BART), Enhanced Representation through Knowledge Integration (ERNIE) models, Conditional Transformer Language Models (CTRL), Generative Pretrained Transformers (GPT), Pathways Language Models (PaLM), other forms of large language models (LLM), or other machine learning models that may perform in context learning. Machine learning model 136 may represent one or more generic, pre-trained traditional machine learning models and/or generative machine learning models that have not been tuned or modified. Machine learning model 136, in the example of FIG. 1, may be a service executing at a computing system separate from computing system 100. Machine learning model 136 may communicate with machine learning system 110 of computing system 100 via network 111.

Some systems may implement supervised learning to train a machine learning model (e.g., machine learning model 136) to perform tasks. However, such systems tend to consume extensive computational resources, is time-consuming, and may be prone to biases and out-of-domain failures. Some systems have implemented in-context learning to allow machine learning models to perform tasks without needing to retrain or update the underlying architecture of the machine learning models. By generating prompts with demonstrations during in-context learning, systems may allow machine learning models to leverage contextual understanding in order to output more relevant and accurate responses without additional training. Some systems may include a large number of demonstrations (e.g., each sample statement of reference data 122) in prompts for in-context learning, which may pose a computational burden (e.g., processing cycles, memory usage, power usage, etc.) when a machine learning model is generating a response to the prompt with a large number of demonstrations. Some systems may implement complex heuristics or rule-based approaches (e.g., diversity factors, complexity factors, etc.) to select demonstrations to be used for generating prompts for in-context learning, which may pose a computational burden associated with implementing the complex heuristics when selecting demonstrations. Such systems tend to not be scalable for generative tasks, may hamper user participation and effectiveness of outputs of machine learning models processing prompts for in-context learning, and may require lots of training data that tends to be over-fitted.

Machine learning system 110 of computing system 100 may, according to the techniques described herein, efficiently select demonstrations for in-context learning prompts based on sample embeddings associated with sample statements of reference data 122 that are ordered according to a similarity to a statement embedding created for an input or target statement (e.g., statement 152). In this way, machine learning system 110 may intelligently select demonstrations for in-context learning prompts in a way that reduces computational resource consumption compared to conventional systems. Machine learning system 110 may, in some examples, implement the in-context learning prompts to cause machine learning model 136 to perform generative tasks (e.g., paraphrase statement generation) with performance comparable to supervised learning approaches, which has not been currently explored.

In accordance with the techniques described herein, machine learning system 110 may generate a prompt that causes machine learning model 136 to perform a task associated with statement 152. For example, machine learning system 110 may generate an in-context learning prompt for machine learning model 136 to classify statement 152 according to classification labels 143 and selected demonstrations. In another example, machine learning system 110 may generate an in-context learning prompt for machine learning model 136 to generate a paraphrased statement for statement 152 according to selected demonstrations. Machine learning system 110 may select demonstrations based on a comparison of content of statement 152 to content of sample statements of reference data 122. Machine learning system 110 may generate a prompt for in-context learning based on the selected demonstrations. For instance, machine learning system 110 may rank or order sample statements of reference data 122 based on similarity scores computed for sample embeddings associated with the sample statements when compared to a statement embedding for statement 152. Machine learning system 110 may select a number of sample statements, as well as respective ground-truth information (e.g., respective classification labels, respective paraphrase statements, etc.), based on the rank or order of the sample statements. In this way, machine learning system 110 may reduce computational resources (e.g., processing cycles, memory usage, power usage, etc.) associated with training machine learning model 136 to perform classification or generation tasks and/or reducing computational resources associated with applying complex heuristics when retrieving demonstrations for a specific task. Machine learning system 110 may reduce computational resources while maintaining qualitative performance of outputs generated by machine learning system 110 implementing the techniques described herein.

Prompt generator 112 of machine learning system 110 may generate respective sample embeddings for a large number of sample statements. Prompt generator 112 may convert raw text or raw audio of each sample statement stored at reference data 122 to a corresponding sample embedding that characterizes content of a respective sample statement in a high-dimensional vector space. For example, prompt generator 112 may apply a machine learning model (e.g., a sentence transformer model) to generate a normalized sample embedding for each sample statement stored at reference data 122. Prompt generator 112 may generate a sample embedding that is normalized such that the sum of each value of the sample embedding equals one. Prompt generator 112 may store respective sample embeddings for the sample sentences of reference data 122 at sample embeddings 142. Sample embeddings 142 may include a storage device configured to store sample embeddings for sample statements of reference data 122. Sample embeddings 142 may store each of the sample embeddings in association with a reference to the corresponding sample statement in reference data 122. The reference may be an identifier, a tag, a pointer, an index, or other data identifying the sample statement and/or associating the sample statement to a corresponding sample embedding. Prompt generator 112 may implement sample embeddings stored at sample embeddings 142 to efficiently select and retrieve demonstrations used in generating prompts for machine learning tasks associated with statement 152.

Prompt generator 112 may receive statement 152 from computing device 150. Prompt generator 112 may receive statement 152 with a request for an output to be generated by machine learning system 110. For example, prompt generator 112 may receive statement 152 with a request to paraphrase statement 152 or a request to classify statement 152. Computing device 150 may send, via network 111, statement 152 to computing system 100. Computing device 150 may send statement 152 in response to a user selecting a send, request paraphrase, or request classification option displayed via GUI 154. Computing device 150 may require the explicit consent of a user operating computing device 150 to send statement 152 to computing system 100.

In some examples, prior to computing system 100 sending statement 152 to an intended recipient, computing system 100 may apply machine learning model 136 to generate and output a paraphrased statement to replace statement 152 as a message sent to the intended recipient. For example, a user operating computing device 150 may draft statement 152 when interacting with GUI 154. Computing device 150 may display GUI 154 with an option for a user to paraphrase statement 152 prior to sending statement 152 to an intended recipient. Computing device 150 may send statement 152 to computing system 100 in response to the user operating computing device 150 selecting the option to paraphrase statement 152. In some instances, computing device 150 may automatically send statement 152 to computing system 100 to paraphrase content of statement 152 and include the paraphrased content in a message sent to the intended recipient.

In some examples, prior to generating the paraphrased statement, computing system 100 may apply machine learning model 136 to determine whether statement 152 is assigned a classification label associated with a trigger for generating a paraphrased statement. For example, machine learning system 110 of computing system 100 may apply machine learning model 136 to determine a classification label for statement 152. Based on the classification label for statement 152 (e.g., a classification label indicating statement 152 is offensive, a classification label indicating statement 152 is in a passive tone, a classification label indicating statement 152 is in a sad tone, etc.) being mapped to a paraphrase trigger, machine learning system 110 may apply machine learning model 136 to generate a paraphrased statement for statement 152. Machine learning system 110 may determine whether a classification label determined for statement 152 maps to a paraphrase trigger based on a mapping of classification labels to the paraphrase trigger stored at classification labels 143. Classification labels 143 may include a storage device configured to store classification labels corresponding to ground-truth labels stored at reference data 122, as well as any mappings of classification labels to a paraphrase trigger.

In response to receiving statement 152, prompt generator 112 may generate a statement embedding for statement 152. Prompt generator 112 may convert raw text or raw audio associated with statement 152 to a statement embedding that characterizes content of statement 152 in a high-dimensional vector space. For example, prompt generator 112 may apply a machine learning model (e.g., a sentence transformer model) to generate a normalized statement embedding for statement 152. Prompt generator 112 may generate a statement embedding that is normalized such that the sum of each value of the statement embedding equals one. In some examples, in instances where statement 152 includes audio data representing an utterance of a statement, machine learning system 110 may apply speech-to-text techniques to convert the audio data of statement 152 to text data prior to providing statement 152 to prompt generator 112. In other examples, where statement 152 includes text data, machine learning system 110 may apply text-to-speech techniques to convert the text data of statement 152 to audio data prior to providing statement 152 to prompt generator 112. In general, machine learning system 110 may convert statement 152 to a data structure that conforms to the data structure of statements stored at reference data 122.

Prompt generator 112 may select a set of demonstrations based on the statement embedding generated for statement 152 and sample embeddings stored at sample embeddings 142. For example, prompt generator 112 may compute a similarity score (e.g., cosine similarity score, Euclidean Distance, Manhattan Distance, Dot Product Similarity, Jaccard Similarity, Pearson Correlation Coefficient, Hamming Distance, Kullback-Leibler Divergence, Wasserstein Distance, Mahalanobis Distance, etc.) for each sample embedding of sample embeddings 142. Prompt generator 112 may compute a similarity score for a sample embedding by comparing the sample embedding to the statement embedding in the high-dimensional vector space. Prompt generator 112 may order or rank each sample embedding based on corresponding similarity scores computed for each sample embedding. For example, prompt generator 112 may order each sample embedding from highest similarity scores to lowest similarity scores (e.g., most similar sample embeddings in descending order). Prompt generator 112 may select a predefined or specified number of sample embeddings based on the order of sample embeddings (e.g., select the top N sample embeddings that have the highest similarity scores). In some instances, prompt generator 112 may select sample embeddings based on one or more similarity score thresholds.

Prompt generator 112 may select, based on the selected sample embeddings and a task associated with statement 152 (e.g., classifying statement 152, paraphrasing statement 152, etc.), demonstrations from reference data 122. For instance, prompt generator 112 select one or more sample statements from reference data 122 based on respective similarity scores computed for the sample embeddings. Prompt generator 112 may fetch demonstrations from reference data 122 as the selected one or more sample statements associated with the selected sample embeddings and at least one of respective ground-truth information for the selected one or more sample statements or respective sample paraphrases for the selected one or more sample statements. Prompt generator 112 may determine a number of demonstrations to include in a prompt to improve performance of machine learning model outputs based on testing how many demonstrations in a prompt improve performance without saturating. In other words, prompt generator 112 may be configured to select a number of demonstrations in a way that maximizes performance and conserves computational resources associated with machine learning model 136 processing the prompt to perform a machine learning model task associated with statement 152.

In instances where machine learning system 110 is tasked to classify statement 152, prompt generator 112 may retrieve, from reference data 122, ground-truth classification labels associated with the selected sample embeddings stored at sample embeddings 142. Prompt generator 112 may select demonstrations from reference data 122 as entries of reference data 122 that include the one or more selected sample statements and corresponding ground-truth classification labels for the one or more selected sample statements. In other words, prompt generator 112 may select demonstrations as the sample statements and corresponding classification labels associated with selected sample embeddings.

In instances where machine learning system 110 is tasked to generate a paraphrased statement for statement 152, prompt generator 112 may retrieve, from reference data 122, respective sample paraphrases for the selected one or more sample statements. Prompt generator 112 may select demonstrations from reference data 122 as entries of reference data 122 that include the one or more selected sample statements and corresponding sample paraphrased statements for the one or more selected sample statements. In other words, prompt generator 112 may select demonstrations as the sample statements and corresponding paraphrased statements associated with selected sample embeddings. In some examples, prompt generator 112 may select demonstrations as the selected one or more sample statements, respective ground truth information for the selected one or more sample statements, and respective paraphrases for the one or more sample statements.

Prompt generator 112 may generate a prompt based on selected demonstrations. For example, prompt generator 112 may generate a prompt to include selected demonstrations and statement 152. In instances where machine learning system 110 is tasked to classify statement 152, prompt generator 112 may include a list of classification labels stored at classification labels 143 in the prompt. In some examples, prompt generator 112 may generate a prompt to include an instruction of a task associated with statement 152 (e.g., an instruction indicating a task specified in a request received from computing device 150). However, prompt generator 112 may not include an instruction of a task associated with statement 152 in the prompt to conserve computational resources (e.g., processing cycles, memory usage, power usage, etc.) associated with generating the instruction. Prompt generator 112 may send the prompt to machine learning model 136. Prompt generator 112 may, for example, send the prompt to machine learning model 136 via network 111.

In examples where machine learning system 110 is tasked to classify statement 152, MLM interface 132 may obtain a classification of statement 152 from machine learning model 136. For example, MLM interface 132 may provide a prompt (e.g., prompt including sample statements and respective ground-truth classification labels selected from reference data 122) generated by prompt generator 112 to machine learning model 136 (e.g., a large language model). MLM interface 132 may apply machine learning model 136 to output a classification for statement 152 based on the prompt. MLM interface 132 may apply machine learning model 136 to determine a classification label of classification labels 143 for statement 152 based on ground-truth classification labels assigned to sample statements of selected demonstrations included in the prompt generated by prompt generator 112. For instance, MLM interface 132 may apply machine learning model 136 to process the prompt generated by prompt generator 112 including sample statements and corresponding ground-truth classification labels to predict a classification label for statement 152, such as a classification label associated with a degree of offensive or toxic content, a classification label associated with an emotion, a classification label associated with a writing style, or the like. MLM interface 132 may obtain the assigned classification label from machine learning model 136. MLM interface 132 may output, via network 111, an indication of the assigned classification label to computing device 150. Computing device 150 may output the indication of the classification label for statement 152 via GUI 154.

In some examples, MLM interface 132 may determine, based on a mapping of classification labels to a paraphrase trigger stored at classification labels 143, whether the assigned classification label for statement 152 is associated with a paraphrase trigger. Based on determining the assigned classification label for statement 152 is associated with a paraphrase trigger, MLM interface 132 may initiate generation of a paraphrased statement for statement 152. MLM interface 132 may task prompt generator 112 to select, based on the statement embedding for statement 152 and selected sample embeddings of sample embeddings 142 (e.g., the top N sample embeddings with the highest similarity scores), demonstrations from reference data 122 to include a set of sample statements with respective paraphrases (e.g., ground-truth, paraphrased statements) stored at reference data 122. Prompt generator 112 may generate a prompt to include the selected demonstrations and statement 152. Prompt generator 112 may provide the prompt to machine learning model 136. Machine learning model 136 may generate a paraphrased statement for statement 152 based on the selected demonstrations included in the prompt. Machine learning model 136 may output the paraphrased statement to MLM interface 132. MLM interface 132 may pre-process the paraphrased statement to output, via network 111, a data structure representing the paraphrased statement (e.g., text strings, audio waveforms, etc.) to computing device 150 and/or an intended recipient of statement 152.

In examples where machine learning system 110 is tasked to generate a paraphrased statement of statement 152, MLM interface 132 may obtain, from machine learning model 136, a paraphrased statement that machine learning model 136 generated based on a prompt machine learning model 136 received from prompt generator 112. For example, MLM interface 132 may instruct prompt generator 112 to provide a prompt (e.g., prompt including sample statements and respective ground-truth, paraphrased statements selected from reference data 122) generated by prompt generator 112 to machine learning model 136 (e.g., a large language model). MLM interface 132 may apply machine learning model 136 to generate and output a paraphrased statement for statement 152 based on the prompt. For example, MLM interface 132 may apply machine learning model 136 to process (e.g., tokenize) statement 152 and the selected demonstrations—including ground-truth paraphrased statements and corresponding sample statements—to generate a paraphrased statement for statement 152. In some examples, MLM interface 132 may apply machine learning model 136 to process a prompt—generated by prompt generator 112—that includes demonstrations with sample statements, respective paraphrased statements, and respective context for the sample statements in the form of prior statements associated with the sample statements (e.g., prior statements made in dialogue or conversation associated with sample statements of reference data 122). In this way, machine learning system 110 may improve performance of generating paraphrased statements by infusing the respective context in the prompt or otherwise making machine learning model 136 aware of the context in the prompt (e.g., a prompt that includes context in the form of preceding statements associated with selected sample statements may result in generated paraphrased statements being less impacted by the context compared to context infused approaches).

MLM interface 132 may output, via network 111, the paraphrased statement to computing device 150. Computing device 150 may output the paraphrased statement for statement 152 via GUI 154. In some examples, MLM interface 132 may output, via network 111, the paraphrased statement to a computing device or computing system that is an intended recipient of statement 152. In other words, MLM interface 132 may output the paraphrased statement in lieu of statement 152, and in the same manner (e.g., as audio data in instances where statement 152 includes audio data, as text data in instances where statement 152 includes text data, etc.) and to the same recipient associated with statement 152.

The techniques may provide one or more technical advantages that realize at least one practical application. For example, machine learning system 110 may accurately and efficiently generate prompts for in-context learning based on a limited number of demonstrations retrieved from reference data 122. Some systems may generate prompts for in-context learning to include all or a randomly selected set of demonstrations of reference data 122, which may result in a computationally expensive process or underperformance. Some systems may also implement heuristics or rules (e.g., diversity of statements, complexity of statements, etc.) when selecting demonstrations, which may result in a computationally expensive process associated implementing such heuristics or rules (e.g., expending additional computational resources to consider heuristics or expending additional computational resources to train or fine-tune a machine learning model to implement rule-based approaches). Such systems that use supervised learning to train a machine learning model (e.g., machine learning model 136) to perform tasks described herein may be prone to over-fitting, biases, and out-of-domain failures. Such systems rely heavily on large quantities of labeled data to help preserve meaning and intent, but tend to retain a large portion of the offensiveness of the original content, raising a question of overall usability for paraphrasing tasks. Machine learning system 110, according to the techniques described herein, may conserve computational resources (e.g., processing cycles, memory usage, power usage, etc.) by intelligently selecting and retrieving a limited number of input-label demonstration pairs to include in a prompt for in-context learning. By carefully ordering demonstrations based on a small volume of available reference data 422, machine learning system 110 may maintain relatively good performance of machine learning model 136 outputs despite having a small number of available demonstrations stored at reference data 422. For example, supervised learning techniques may use sample statements on the order of millions to train a machine learning model and heuristic or rule-based approaches may use sample statements on the order of thousands to effectively perform in-context learning. Rather, machine learning system 110, according to the techniques described herein, may perform in-context learning with sample statements on the order of hundreds (e.g., only 10% of a dataset of sample statements) which improves memory and processing utilization of computing system 100 when performing in-context learning.

Machine learning system 110 may, additionally or alternatively, further save computational resources by generating a prompt to not include an instruction of a task. Machine learning system 110 may apply a machine learning model to generate an output by inferring a task based on selected demonstrations included in the prompt provided to the machine learning model. Machine learning system 110 may apply the machine learning model to generate and output responses to in-context learning queries that are similar to ground-truth information for sample statement included in the selected demonstrations of the prompt. In this way, machine learning system 110 may apply a single machine learning model to generate outputs for various tasks (e.g., classifying statement 152, generating a paraphrased statement for statement 152, etc.) without training the machine learning model to perform the various tasks.

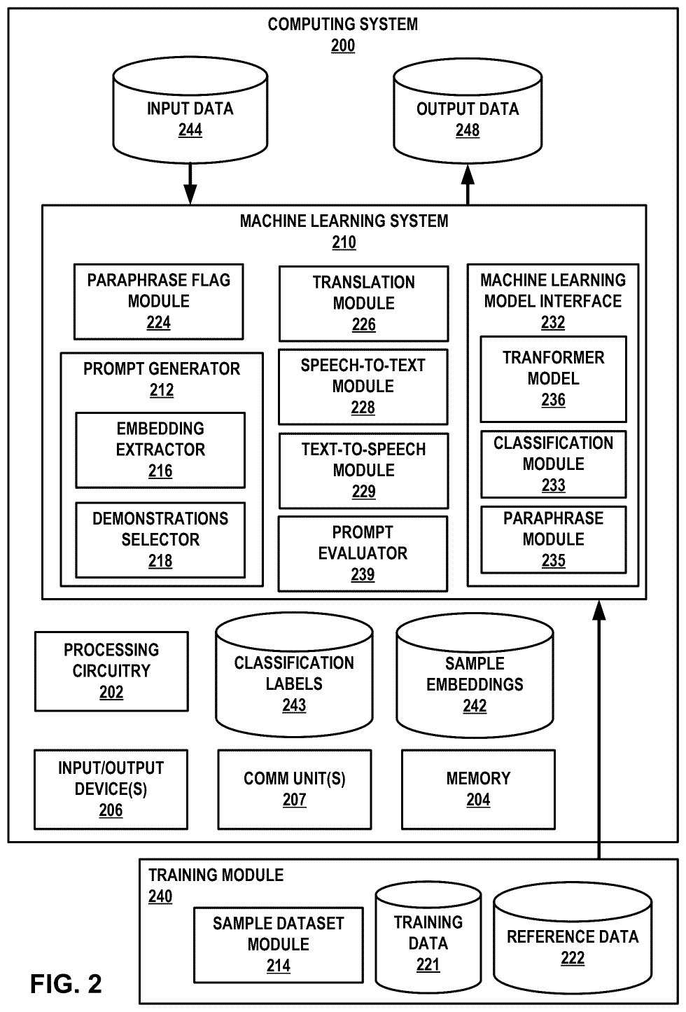

FIG. 2 is a block diagram illustrating example computing system 200 with example machine learning system 210 configured to generate prompts for in-context learning, in accordance with techniques of this disclosure. Computing system 200, machine learning system 210, prompt generator 212, machine learning model interface 232, sample embeddings 242, classification labels 243, transformer model 236, and reference data 222 of FIG. 2, may be example or alternative implementations of computing system 100, machine learning system 110, prompt generator 112, MLM interface 132, sample embeddings 142, classification labels 143, machine learning model 136, and reference data 122 of FIG. 1, respectively.

Training module 240, in the example of FIG. 2, may be stored at a storage device external to computing system 200 (e.g., a separate training computing system). In some examples, training module 240 may be stored at computing system 200. Training module 240 may include a software module with computer-readable instructions for training components of machine learning system 210 and/or generating reference data 222. Training module 240, in the example of FIG. 2, may include sample dataset module 214, reference data 222, and training data 221. Training data 221 may include training data for training components of machine learning system 210. In some examples, training data 221 may include sample statements from a dialogue-style corpus of sample statements that sample dataset module 214 may use to generate reference data 222. Sample dataset module 214 may generate reference data 222 as a dataset including sample statements and respective ground-truth information associated with a machine learning model task (e.g., classify a statement, generate a paraphrased version of a statement, generate a response to a statement, etc.). For example, sample dataset module 214 may generate reference data 222 to include sample statements and respective ground-truth information including respective classification labels, respective paraphrased statements, respective context in the form of previous statements associated with a sample statement, respective sample responses, or the like.

Sample dataset module 214 may generate reference data 222 based on training data 221. Sample dataset module 214 may include computer-readable instructions for training and applying a machine learning model (e.g., a transformer-based model) to generate reference data 222 based on training data 221. For example, in instances where sample dataset module 214 generates reference data 222 to include offensive or rude sample statements with respective paraphrased statements that are inoffensive, training data 221 may include sample statements (e.g., dialogue-style or other conversational type sentences) that have been annotated or otherwise labeled based on a rudeness or politeness scale, as well as unlabeled sample statements. For instance, training data 221 may include sample statements labeled as either polite, neutral, or rude sentences. Sample dataset module 214 may train and fine-tune, using annotated sample statements of training data 221, the machine learning model as a three-class model capable of predicting whether an input statement is a polite, neutral, or rude sentence.

Sample dataset module 214 may apply the fine-tuned machine learning model to annotate unlabeled sample statements stored at training data 221. Additional unlabeled sample statements may be added to training data 221 for additional training of the machine learning model of sample dataset module 214. Sample dataset module 214 may update the fine-tuned machine learning model based on performance of the machine learning model in annotating the unlabeled sample statements of training data 221. Sample dataset module 214 may apply the updated machine learning model to annotate additional unlabeled sample statements of training data 221. For example, sample dataset module 214 may apply the updated machine learning model to label unlabeled sample statements of training data 221 as rude, polite, or neutral. Sample dataset module 214 may select sample statements labeled as rude as an intermediate dataset including rude statements without polite paraphrases. In some examples, sample dataset module 214 may generate the intermediate dataset to include context in the form of prior statements from a dialogue that precede a sample statement labeled as rude. Sample dataset module 214 may generate reference data 222 to include ground-truth information for a sample statement that includes context for the sample statement in the form of prior statements associated with the sample statement. In this way, machine learning system 210 may improve performance of machine learning model outputs based on incorporating respective context for sample statements in prompts for in-context learning.

Sample dataset module 214 may apply a second machine learning model (e.g., a transformer model) to generate polite paraphrases for each sample statement included in the intermediate dataset. Sample dataset module 214 may generate reference data 222 to include sample statements labeled as rude and respective polite paraphrases generated for the rude sample statements. In some examples, sample dataset module 214 may generate reference data 222 to include sample statements labeled as polite and/or neutral. In some instances, sample dataset module 214 may generate reference data 222 to include sample statements with ground-truth information (e.g., classification labels, paraphrase examples, context in the form of previous statements associated with a sample statement, response examples, etc.) that have been obtained from an external source (e.g., the Internet). In general, sample dataset module 214 may generate reference data 222 to include sample statements (e.g., dialogue-style statements), classification labels that the machine learning models of sample dataset module 214 assigned to the sample statements, and respective sample paraphrases for sample statements associated with a particular label (e.g., respective sample paraphrases for a set of sample statements labeled as “offensive”). In this way, demonstrations selector 218 of prompt module 212 may retrieve selected sample statements (e.g., sample statements labeled as “offensive” that have a similarity score with respect to a target statement that satisfies a threshold) for demonstrations from reference data 122, and generate a prompt to include respective paraphrases and/or respective ground-truth information for sample statements for demonstrations from reference data 122. By sample dataset module 214 generating a robust dataset to store at reference data 222, machine learning system 210 may generate effective prompts with a limited number of sample statements without implementing any heuristics or rules associated with diversity or complexity of sample statements within the dataset.

Computing system 200 comprises any suitable computing system having one or more computing devices, such as servers, desktop computers, laptop computers, gaming consoles, smart televisions, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, for transmitting data between computing systems, servers, and computing devices.

Computing system 200, in the example of FIG. 2, may include processing circuitry 202, machine learning system 210, classification labels 243, sample embeddings 242, one or more input/output (I/O) devices 206 (referred to herein as “I/O devices 206”), and one or more communication units (“COMM” units) 207 having access to memory 204. One or more input devices of I/O devices 206 may generate, receive, or process input. Such input may include input from a keyboard, pointing device, voice responsive system, video camera, biometric detection or response system, button, sensor, mobile device, control pad, microphone, presence-sensitive screen, network, or any other type of device for detecting input from a human or machine. One or more output devices of I/O devices 206 may generate, transmit, or process output. Examples of output are tactile, audio, visual, and/or video output. I/O devices 206 may include a display, sound card, video graphics adapter card, speaker, presence-sensitive screen, one or more USB interfaces, video and/or audio output interfaces, or any other type of device capable of generating tactile, audio, video, or other output. I/O devices 206 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output.

One or more communication units 207 of computing system 200 may communicate with devices external to computing system 200 (or among separate computing devices of computing system 200) by transmitting and/or receiving data, and may operate, in some respects, as both an input device and an output device. In some examples, communication units 207 may communicate with other devices over a network. In other examples, communication units 207 may send and/or receive radio signals on a radio network such as a cellular radio network. Examples of communication units 207 may include a network interface card (e.g., such as an Ethernet card), an optical transceiver, a radio frequency transceiver, a GPS receiver, or any other type of device that can send and/or receive information. Other examples of communication units 207 may include Bluetooth®, GPS, 3G, 4G, and Wi-Fi® radios found in mobile devices as well as Universal Serial Bus (USB) controllers and the like.

Processing circuitry 202 and memory 204 may be configured to execute machine learning system 210 to generate prompts for in-context learning associated with input data 244, according to techniques of this disclosure. Memory 204 may store information for processing during operation of prompt generator 212, paraphrase flag module 224, translation module 226, speech-to-text module 228, text-to-speech module 229, and machine learning model interface 232. In some examples, memory 204 may include temporary memories, meaning that a primary purpose of the one or more storage devices is not long-term storage. Memory 204 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art. Memory 204, in some examples, also include one or more computer-readable storage media. Memory 204 may be configured to store larger amounts of information than volatile memory. Memory 204 may further be configured for long-term storage of information as non-volatile memory space and retain information after activate/off cycles. Examples of non-volatile memories include magnetic hard disks, optical discs, floppy disks, Flash memories, or forms of electrically programmable memories (EPROM) or electrically erasable and programmable (EEPROM) memories. Memory 204 may store program instructions and/or data associated with one or more of the modules (e.g., prompt generator 212, paraphrase flag module 224, translation module 226, speech-to-text module 228, text-to-speech module 229, and machine learning model interface 232 of machine learning system 210) described in accordance with one or more aspects of this disclosure.

Processing circuitry 202 and memory 204 may provide an operating environment or platform for prompt generator 212, paraphrase flag module 224, translation module 226, speech-to-text module 228, text-to-speech module 229, and machine learning model interface 232, which may be implemented as software, but may in some examples include any combination of hardware, firmware, and software. Processing circuitry 202 may execute instructions and memory 204 may store instructions and/or data of one or more modules. The combination of processing circuitry 202 and memory 204 may retrieve, store, and/or execute the instructions and/or data of one or more applications, modules, or software. Processing circuitry 202 and memory 204 may also be operably coupled to one or more other software and/or hardware components, including, but not limited to, one or more of the components illustrated in FIG. 2. Processing circuitry 202, machine learning system 210, sample embeddings 242, classification labels 243, I/O devices 206, communication units 207, and memory 204 may each be distributed over one or more computing devices.

In the example of FIG. 2, machine learning system 210 may include prompt generator 212, paraphrase flag module 224, translation module 226, speech-to-text module 228, text-to-speech module 229, prompt evaluator 239, and machine learning model interface 232. Prompt generator 212 may include embedding extractor 216 and demonstrations selector 218. Embedding extractor 216 may include computer-readable instructions for applying a machine learning model (e.g., a transformer model) trained to compute embeddings for statements. Embedding extractor 216 may apply the machine learning model to generate sample embeddings for each sample statement stored at reference data 222. Embedding extractor 216 may apply the machine learning model to generate a sample embedding for a sample statement that captures content of the sample statement in a high dimensional vector space.

For example, embedding extractor 216 may provide a sample statement of reference data 222 to the machine learning model. The machine learning model of embedding extractor 216 may tokenize the sample statement by splitting the sample statement into words or sub-words. The machine learning model of embedding extractor 216 may convert the generated tokens into numerical representations that are further converted to dense vector embeddings using an embedding layer that maps the numerical representations to a high-dimensionality vector space where semantically similar tokens are represented similarly. Embedding extractor 216 may, additionally or alternatively, add positional embeddings to the dense vector embeddings to encode a position of each token in a sequence of tokens associated with the sample statement. The machine learning model of embedding extractor 216 may pass the dense vector embeddings for tokens associated with the sample statement through one or more transformer layers that may include multi-head self-attention mechanisms, feed-forward neural networks, or the like. As the dense vector embeddings for tokens associated with the sample statement pass through the one or more transformer layers, each output of a transformer layer transforms the dense vector embeddings to contextual embeddings that capture contextual information for respective tokens associated with the sample statement. Embedding extractor 216 may pool (e.g., using mean pooling, max pooling, etc.) the final contextual embedding outputs of the one or more transformer layers to generate a sample embedding for the sample statement. Embedding extractor 216 may store sample embeddings generated for each sample statement of reference data 222 at sample embeddings 242. In this way, embedding extractor 216 may pre-process a robust number of sample statements into sample embeddings that are stored prior to inference time to improve compute time or inference time of machine learning system 210 performing in-context learning.

Embedding extractor 216 may generate a statement embedding for an input statement included in input data 244. Input data 244 may include an input statement as audio data representing an utterance of a statement, text data representing a statement, or other modes of data representing a statement. In some examples, in instances where input data 244 includes audio data, machine learning system 210 may apply speech-to-text module 228 to convert the audio data to text data. Speech-to-text module 228 may apply automatic speech recognition (ASR) techniques (e.g., template matching, hidden Markov models, Gaussian mixture models, deep neural networks, convolutional neural networks, recurrent neural networks, attention mechanisms, end-to-end ASR models, etc.) to convert audio data of a sample statement of input data 244 to text data including strings of words spoken in the audio data. Speech-to-text module 228 may provide embedding extractor 216 the text data as a sample statement. Embedding extractor 216 may generate a statement embedding for the sample statement similarly to how embedding extractor 216 generates sample embeddings for the sample statements of reference data 222. For example, embedding extractor 216 may apply the machine learning model to process the sample statement (e.g., tokenize, map to the high-dimensional vector space, pass through transformer layers, pool, etc.) to generate a statement embedding that captures content of the sample statement in a high-dimensional vector space. Embedding extractor 216 may provide the statement embedding to demonstrations selector 218.

Demonstrations selector 218 of prompt generator 212 may select demonstrations from reference data 222 based on a statement embedding for an input statement of input data 244 and sample embeddings for sample statements of reference data 222. Demonstrations selector 218 may determine similarity scores for each sample embedding of sample embeddings 242 with respect to the statement embedding. For example, demonstrations selector 218 may determine a similarity score for a sample embedding of sample embeddings 242 by computing a cosine similarity score between the statement embedding and the sample embedding. Demonstrations selector 218 may select a predefined number of sample embeddings of sample embeddings 242 based on determined similarity scores for each sample embedding. For example, demonstrations selector 218 may select a predefined number of sample embeddings from sample embeddings 242 based on an order or rank of the sample embeddings according to similarity scores. Demonstrations selector 218 may select demonstrations from reference data 222 based on the selected sample embeddings. For example, demonstrations selector 218 may select demonstrations from reference data 222 as sample statements and respective ground-truth information associated with the selected sample embeddings. Demonstrations selector 218 may select sample statements for demonstrations that are most similar to a target or input statement for better performance of transformer model 236 processing the demonstrations. Demonstrations selector 218 may order sample statements based on similarity scores computed for corresponding sample embeddings and without heuristics or rules associated with diversity or complexity of the sample statements. Demonstrations selector 218 may select sample statements based on the order of sample statements in a way that improves performance of prompts for in-context learning tasks and reduces computational resources associated with generating prompts for in-context learning tasks. By carefully selecting demonstrations based on sample statements ordered according to similarity scores, demonstrations selector 218 may generate robust prompts with minimal performance loss due to a reduced or limited number of sample statements. In other words, the simple and fast approach implemented by demonstrations selector 218 to order and select sample statements based on similarity scores improves computational resource utilization of computing system 200 performing in-context learning with only marginal performance trade-offs compared to other techniques such as supervised learning or heuristic or rule-based approaches.

Demonstrations selector 218 may generate a prompt for in-context learning based on selected demonstrations from reference data 222. In instances where machine learning system 210 is tasked to classify an input statement of input data 244, demonstrations selector 218 may generate a prompt to include the input statement, as well as demonstrations including sample statements and assigned classification labels (e.g., polite, neutral, or rude) associated with selected sample embeddings. In some examples, demonstrations selector 218 may generate the prompt to further include a list of possible classification labels stored at classification labels 243. Demonstrations selector 218 may provide the prompt to classification module 233 of machine learning model interface 232.

Classification module 233 may apply transformer model 236 to determine a classification label for the input statement of input data 244. Transformer model 236 may include a machine learning model such as large language models (LLMs), a bidirectional encoder representations from transformers (BERT) based model, a generative pre-trained transformer (GPT) based model, or the like. Transformer model 236 may include a machine learning model that has not been trained to perform any specific task. Classification module 233 may apply transformer model 236 to determine a classification label of classification labels 243 for an input statement of input data 244 by providing the prompt to transformer model 236. Transformer model 236 may process the prompt to output, to classification module 233, a classification label for the input statement of input data 244. Transformer model 236 may apply in-context learning to infer a pattern associated with the demonstrations. Transformer model 236 may predict a classification label for the input statement based on the inferred pattern. In some examples, in instances where the prompt does not include an instruction of a task, transformer model 236 may infer the task of determining a label for the input statement based on the demonstrations including sample statements and respective classification labels. Classification module 233 may output the determined classification for the input statement of input data 244 as output data 248. In some examples, classification module 233 may send the determined classification label for the input statement to paraphrase flag module 224.

Paraphrase flag module 224 may determine whether the classification label for the input statement is associated with a paraphrase trigger flag. Paraphrase flag module 224 may store a mapping of classification labels to paraphrase trigger flags. For example, paraphrase flag module 224 may store a mapping of a “rude” classification label to a paraphrase trigger flag. Based on paraphrase flag module 224 determining the classification label for the input statement is associated with a paraphrase trigger, paraphrase flag module 224 may send instructions to demonstrations selector 218 to generate a prompt to paraphrase the input statement associated with the paraphrase flag trigger.

In instances where machine learning system 210 is tasked to paraphrase the input statement of input data 244, demonstrations selector 218 may generate a prompt that includes the input statement, as well as demonstrations of reference data 222 including sample statements and respective paraphrased statements (e.g., respective polite paraphrases) associated with selected sample embeddings of sample embeddings 242 (e.g., sample embeddings selected based on similarity scores determined between each of the sample embeddings of sample embeddings 242 and a statement embedding for the input statement of input data 244). In some examples, demonstrations selector 218 may generate the prompt to further include respective ground-truth information associated with selected sample statements that includes context associated with the selected sample statements, such as previous statements associated with the selected sample statements that are stored as the dialogue-style sample statements of reference data 222. Demonstrations selector 218 may provide the prompt to paraphrase module 235 of machine learning model interface 232.

Paraphrase module 235 may apply transformer model 236 to generate a paraphrased statement for the input statement of input data 244. Paraphrase module 235 may apply transformer model 236 by providing transformer model 236 with the prompt that includes the input statement and demonstrations including sample statements and respective paraphrased statements. Transformer model 236 may process the prompt to output, to paraphrase module 235, a paraphrased statement for the input statement. Transformer model 236 may apply in-context learning to infer a pattern associated with the demonstrations. Transformer model 236 may generate a paraphrase statement for the input statement based on the inferred pattern. In some examples, in instances where the prompt does not include an instruction of a task, transformer model 236 may infer the task of paraphrasing the input statement based on the demonstrations including sample statements and respective paraphrased statement. Paraphrase module 235 may output the paraphrased statement for the input statement of input data 244 as output data 248.

Prompt evaluator 239 of machine learning system 210 may evaluate performance of outputs of transformer model 236. Prompt evaluator 239 may evaluate performance of outputs of transformer model 236 according to various metrics. For example, prompt evaluator 239 may evaluate performance of outputs of transformer model 236, given a particular prompt, according to metrics that detect offensiveness of statements such as Bilingual evaluation Understudy (BLEU), Bidirectional Encoder Representations from Transformers (BERT) scores (e.g., BERT-F1), Recall-Oriented Understudy for Gisting Evaluation (ROUGE), Consensus-based Image Description Evaluation (CIDEr), Toxicity, or other metrics that may be developed or trained to score performance of transformer model 236 outputs. Prompt evaluator 239 may determine that prompts with a greater number of demonstrations improves performance of transformer model 236 but eventually saturates at a particular number of demonstrations. Prompt evaluator 239 may determine that ordering and selection of demonstrations, according to the techniques described herein, improves performance of transformer model 236 compared to random selections of demonstrations.

In some examples, prompt evaluator 239 may determine an instruction to include in prompts for machine learning tasks. Prompt evaluator 239 may instruct prompt generator 212 and MLM interface 232 to perform in-context learning with prompts having different instructions. For example, prompt evaluator 239 may instruct prompt generator 212 to generate a first prompt with no instruction, a second prompt with a context-free instruction (e.g., instruction with no dialogue context associated with selected sample statements), a third prompt with a context-infused instruction (e.g., instruction with dialogue context that significantly influences outputs of transformer model 236), and a fourth prompt with a context-aware instruction (e.g., instruction with dialogue context where the outputs of transformer model 236 are less impacted by the dialogue context). Prompt evaluator 239 may determine which prompt results in better scoring metric values for outputs of transformer model 236 applying the prompts. Prompt evaluator 239 may determine an instruction for a prompt for in-context learning tasks based on the scoring metrics values associated with the different types of prompts. In this way, prompt evaluator 239 may determine an instruction that optimizes performance of in-context learning tasks while utilizing minimal amounts of computational resources. By determining the best instruction for particular in-context learning tasks, machine learning system 210 may perform better at in-context learning tasks in a way that reduces overhead of a user or machine learning system 210 determining an instruction for prompts.

In some examples, in instances where machine learning system 210 applies speech-to-text module 228 to convert audio data of an input statement of input data 244 to text data for the input statement, machine learning system 210 may convert text data of a paraphrased statement output by paraphrase module 235 to audio data using text-to-speech module 229. Text-to-speech module 229 may include one or more text-to-speech (TTS) models configured to generate audio data of a speaker speaking input text data. Machine learning system 210 may apply text-to-speech module 229 to convert text data of a paraphrased statement to audio data for the paraphrased statement. Machine learning system 210 may output the audio data for the paraphrased statement as output data 248.

In some examples, an input statement of input data 244 may be a statement that is written or spoken in a language different than a language associated with sample statements of reference data 222. In such examples, machine learning system 210 may apply translation module 226 to translate the input statement of input data 244 and/or the paraphrased statement generated by paraphrase module 235 to the language associated with the sample statements of reference data 222. Translation module 226 may apply machine translation techniques to automatically translate text or speech from one language to another. Translation module 226 may translate text or speech using various approaches such as rule-based machine translation, statistical machine translation, neural machine translation, phrase-based machine translation, hybrid machine translation, zero-shot translation, or the like. In some instances, translation module 226 may translate a paraphrased statement output by paraphrase module 235 to generate a translated paraphrased statement. Machine learning system 210 may output the translated paraphrased statement as output data 248.

In some examples, translation module 226 may generate a translated input statement for an input statement of input data 244 to be an input statement in a language associated with sample statements of reference data 222. Prompt generator 212 may generate a prompt with the translated input statement and demonstrations of reference data 222 that include sample statements that are semantically similar to the translated input statement and respective ground-truth classification labels for the sample statements. Machine learning model interface 232 may assign a classification label to the translated input statement based on the prompt. Based on paraphrase flag module 224 determining the assigned classification label is associated with a paraphrase trigger flag, prompt generator 212 may generate a second prompt to include the translated input statement and demonstrations of reference data 222 that include the semantically similar sample statements and respective ground-truth paraphrased statements for the sample statements. Machine learning model interface 232 may generate a paraphrased statement for the translated input statement based on the second prompt. Machine learning system 210 may output the paraphrased statement for the translated input statement as output data 248.

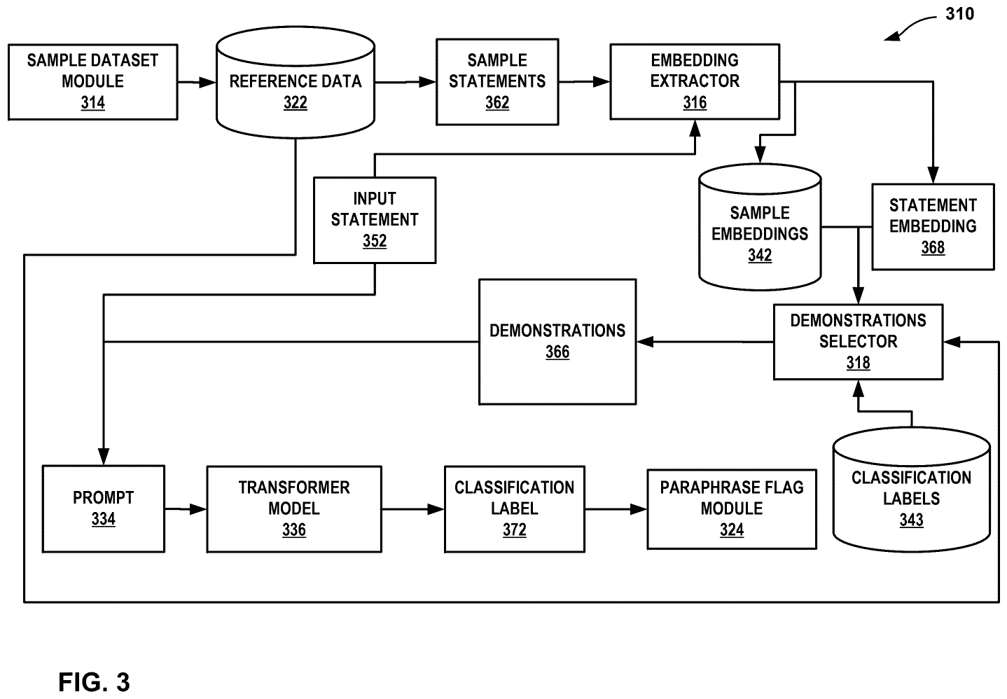

FIG. 3 is a conceptual diagram illustrating example machine learning system 310 for determining example classification label 372 for example input statement 352, in accordance with techniques of this disclosure. Machine learning system 310, sample dataset module 314, reference data 322, embedding extractor 316, sample embeddings 342, demonstrations selector 318, classification labels 343, transformer model 336, and paraphrase flag module 324 of FIG. 3 may be example or alternative implementations of machine learning system 210, sample dataset module 214, reference data 222, embedding extractor 216, sample embeddings 242, demonstrations selector 218, classification labels 243, transformer model 236, and paraphrase flag module 224 of FIG. 2, respectively.

Sample dataset module 314 may generate reference data 322. Sample dataset module 314 may generate reference data 322 to include sample statements with respective ground-truth information. For example, sample dataset module 314 may generate reference data 322 to include entries of sample statements that have respective ground-truth information such as classification labels or paraphrased statements. Sample dataset module 314 may generate reference data 322 based on training data including a large corpus of labeled and/or unlabeled sample statements.

Machine learning system 310 may extract sample statements 362 from reference data 322. Sample statements 362 may include audio data or text data of sample statements with respective ground-truth information stored at reference data 322. Machine learning system 310 may provide sample statements 362 to embedding extractor 316. Embedding extractor 316 may apply a machine learning model to generate sample embeddings for each sample statement of sample statements 362 that captures content of respective sample statements in a high-dimensional vector space. Embedding extractor 316 may store the sample embeddings for sample statements 362 as sample embeddings 342.

Machine learning system 310 may provide input statement 352 to embedding extractor 316. Input statement 352 may include audio data or text data of a statement to be analyzed (e.g., statement 152 of FIG. 1). Embedding extractor 316 may apply a machine learning model to generate statement embedding 368 for input statement 352 that captures content of input statement 352 in a high-dimensional vector space. Embedding extractor 316 may provide statement embedding 368 to demonstrations selector 318.

Demonstrations selector 318 may generate prompt 334 based on sample embeddings 342 and statement embedding 368. Demonstrations selector 318 may compute a set of similarity scores including similarity scores computed between statement embedding 368 and each sample embedding of sample embeddings 342. Demonstrations selector 318 may select a number of sample embeddings based on the set of similarity scores. For example, demonstrations selector 318 may select sample embeddings from sample embeddings 342 based on whether similarity scores associated with the selected sample embeddings satisfy a threshold. Demonstrations selector 318 may retrieve demonstrations 366 based on the selected sample embeddings. For example, demonstrations selector 318 may retrieve demonstrations 366 from reference data 322 to include entries of reference data 322 associated with the selected sample embeddings, where the entries of reference data 322 associated with the selected sample embeddings include sample statements associated with the selected sample embeddings and corresponding classification labels for the sample statements. Demonstrations selector 318 may generate prompt 334 to include demonstrations 366 and input statement 352. In some examples, demonstrations selector 318 may include classification labels stored at classification labels 343 in prompt 334.

Machine learning system 310 may provide prompt 334 to transformer model 336. Transformer model 336 may infer a pattern and task based on demonstrations 366 included in prompt 334. Transformer model 336 may process prompt 334 to determine classification label 372 for input statement 352. Machine learning system 310 may provide classification label 372 to paraphrase flag module 324. Paraphrase flag module 324 may determine whether classification label 372 is associated with a paraphrase trigger flag. In response to paraphrase flag module 324 determining classification label 372 is associated with a paraphrase trigger flag, paraphrase flag module 324 may generate instructions for machine learning system 310 to generate a paraphrased statement for input statement 352.

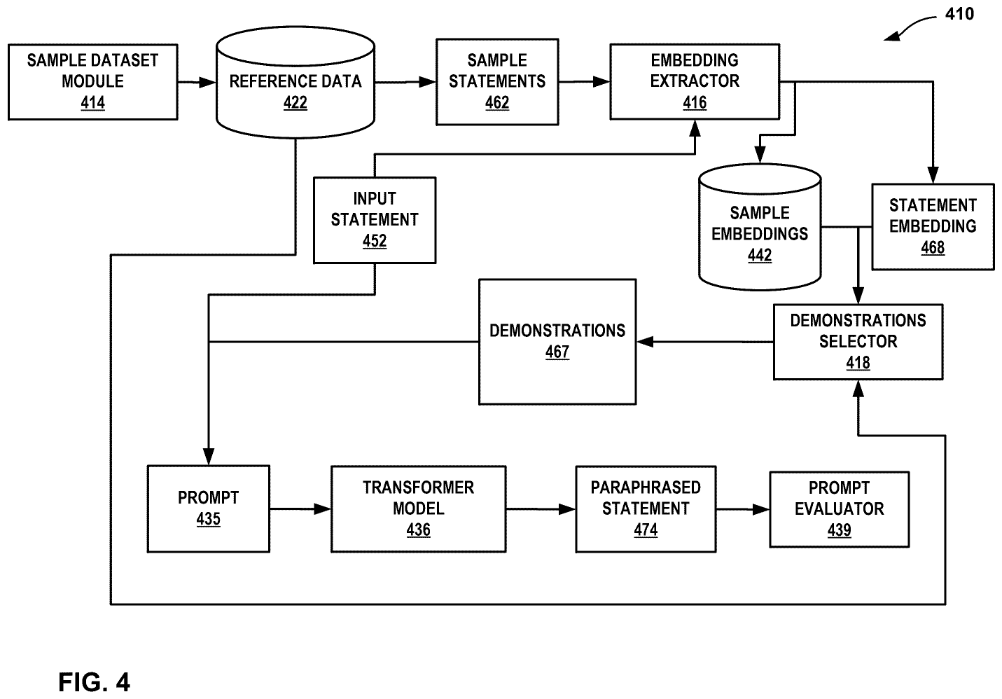

FIG. 4 is a conceptual diagram illustrating example machine learning system 410 for determining example paraphrased statement 474 for example input statement 452, in accordance with techniques of this disclosure. Machine learning system 410, sample dataset module 414, reference data 422, sample statements 462, input statement 452, embedding extractor 416, sample embeddings 442, statement embedding 468, demonstrations selector 418, and transformer model 436 of FIG. 4 may be example or alternative implementations of machine learning system 310, sample dataset module 314, reference data 322, sample statements 362, input statement 352, embedding extractor 316, sample embeddings 342, statement embedding 368, demonstrations selector 138, and transformer model 336 of FIG. 3, respectively.

Sample dataset module 414 may generate reference data 422. Sample dataset module 414 may generate reference data 422 to include sample statements with respective ground-truth information. For example, sample dataset module 414 may generate reference data 422 to include entries of sample statements that have respective ground-truth information such as classification labels or paraphrased statements. Sample dataset module 414 may generate reference data 422 based on training data including a large corpus of labeled and/or unlabeled sample statements. In some examples, sample dataset module 414 may generate reference data 422 based on training data of sample statements in a dialogue-style dataset to include contextual information in prompts for in-context learning.

Machine learning system 412 may extract sample statements 462 from reference data 422. Sample statements 462 may include audio data or text data of sample statements with respective ground-truth information stored at reference data 422. Machine learning system 410 may provide sample statements 462 to embedding extractor 416. Embedding extractor 416 may apply a machine learning model to generate sample embeddings for each sample statement of sample statements 462 that captures content of respective sample statements in a high-dimensional vector space. Embedding extractor 416 may store the sample embeddings for sample statements 462 as sample embeddings 442.

Machine learning system 410 may provide input statement 452 to embedding extractor 316. Input statement 452 may include audio data or text data of a statement to be analyzed (e.g., statement 152 of FIG. 1). Embedding extractor 416 may apply a machine learning model to generate statement embedding 468 for input statement 452 that captures content of input statement 452 in a high-dimensional vector space. Embedding extractor 416 may provide statement embedding 468 to demonstrations selector 418.

Demonstrations selector 418 may generate prompt 435 based on sample embeddings 442 and statement embedding 468. Demonstrations selector 418 may compute a set of similarity scores including similarity scores computed between statement embedding 468 and each sample embedding of sample embeddings 442. Demonstrations selector 418 may select a number of sample embeddings based on the set of similarity scores. For example, demonstrations selector 418 may select sample embeddings from sample embeddings 442 based on whether similarity scores associated with the selected sample embeddings satisfy a threshold. Demonstrations selector 418 may retrieve demonstrations 467 based on the selected sample embeddings. For example, demonstrations selector 418 may retrieve demonstrations 467 from reference data 422 to include entries of reference data 422 associated with the selected sample embeddings, where the entries of reference data 422 associated with the selected sample embeddings include sample statements associated with the selected sample embeddings and corresponding paraphrased statements for the sample statements. Demonstrations selector 418 may generate prompt 435 to include demonstrations 467 and input statement 452.

Machine learning system 410 may provide prompt 435 to transformer model 436. Transformer model 436 may infer a pattern and task based on demonstrations 467 included in prompt 435. Transformer model 436 may process prompt 435 to generate paraphrased statement 474. For example, transformer model 436 may apply in-context learning to generate paraphrased statement 474 that includes audio data or text data of a paraphrased statement that maintains the intent of input statement 452 but with words that are rephrased in a manner similar to how paraphrased statements included in demonstrations 462 rephrased respective sample statements.

Prompt evaluator 439 in the example of FIG. 4 may be an example or alternative implementation of prompt evaluator 239 of FIG. 2. Machine learning system 410 may provide paraphrased statement 474 to prompt evaluator 439 to determine a performance of transformer model 436 given prompt 435. Prompt evaluator 439 may determine a performance of transformer model 436 generating paraphrased statement 474 according to one or more scoring metrics. For example, prompt evaluator 439 may determine a toxicity value for paraphrased statement 474 based on a model that has been developed and trained to identify an offensiveness of a statement.

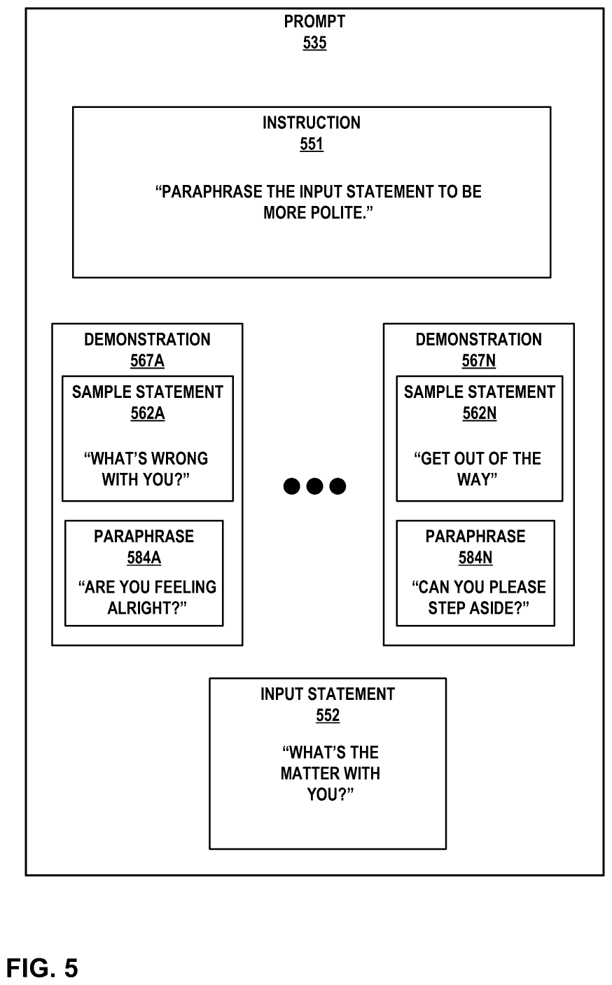

FIG. 5 is a conceptual diagram illustrating example prompt 535 for in-context learning, in accordance with techniques of this disclosure. Prompt 535, demonstrations 567A-567N (collectively referred to herein as “demonstrations 567”), sample statements 562A-562N (collectively referred to herein as “sample statements 562”), and input statement 552 of FIG. 5 may be an example or alternative implementation of prompt 435, demonstrations 467, a subset of sample statements 462, and input statement 452 of FIG. 4, respectively. FIG. 5 may be discussed with respect to FIG. 4 for example purposes only.

Demonstrations selector 418 may generate prompt 535 to include instruction 551, demonstrations 567, and input statement 552. Instruction 551 may include a string data structure of an instruction for an in-context learning task. In the example of FIG. 5, demonstrations selector 418 may include instruction 551 in prompt 535 stating “Paraphrase the input statement to be more polite.” In some examples, demonstrations selector 418 may generate prompt 535 to not include instruction 551. Demonstrations selector 418 may determine not to include instruction 551 based on, for example, prompt evaluator 439 determining no performance degradation if instruction 551 is not included in the prompt. In some examples, demonstrations selector 418 may include instruction 551 that has been defined based on an instruction analysis conducted by prompt evaluator 439. For example, prompt evaluator 439 may evaluate performance of in-context learning tasks given different instructions. Prompt evaluator 439 may send the highest-performing instruction to demonstrations selector 418 as instruction 551. In general, demonstrations selector 418 may determine whether to include instruction 551 based on prompt evaluator 439 evaluating the trade-offs between efficiency and performance of whether to include instruction 551.

Demonstrations 567 of FIG. 5 may include sample statements 562 and respective paraphrases 584A-584N (collectively referred to herein as “paraphrases 584”). Demonstrations selector 418 may select demonstrations 567 based on a comparison of a statement embedding for input statement 552 to sample embeddings for each sample statement of reference data 422. Demonstrations selector 418 may select sample statements 562 from all the sample statements of reference data 422 based on sample statements 562 being semantically and/or contextually similar to input statement 552, for example. In the example of FIG. 5, demonstrations selector 418 may select sample statements 562 (e.g., “what's wrong with you?”, “get out of the way,” etc.) based on sample embeddings for sample statements 562 being the top N-number of sample statements with the highest similarity score when compared to a statement embedding for input statement 552 (e.g., “what's the matter with you?”).

Demonstrations selector 418 may retrieve demonstrations 567 as pairs of sample statements 562 and respective ground-truth information that may be used to infer a pattern and task for in-context learning. In the example of FIG. 5, demonstrations selector 418 may retrieve demonstrations 567 as pairs of sample statements 562 and respective paraphrases 584. For example, demonstrations selector 418 may retrieve demonstration 567A as a pair of sample statement 562A and paraphrase 584A, demonstration 567N as a pair of sample statement 562N and paraphrase 584N, and so on. Pairs of sample statements 562 and respective paraphrase 584 may be stored at reference data 422. In some instances, machine learning system 410 may retrieve pairs of sample statements 562 and respective paraphrases 584 from an external source. In some examples, sample dataset module 414 may apply a machine learning model (e.g., a transformer model) trained to generate paraphrases 584 for respective sample statements 562. For example, sample dataset module 414 may apply the machine learning model to generate paraphrase 584A reciting “Are you feeling alright?” based on sample statement 562A reciting “what's wrong with you?”, paraphrase 584N reciting “Can you please step aside?” based on sample statement 567N reciting “get out of the way,” and so on. Sample dataset module 414 may store generated paraphrases with respective sample statements at reference data 422 for retrieval by demonstrations selector 418 when generating prompt 535.

In the example of FIG. 5, demonstrations selector 418 may generate prompt 535 to not include an instruction of a task to be performed on input statement 552. In this way, machine learning system 410 may conserve computational resources associated with generating an instruction for prompt 535, as well as avoid negative performance associated with bad instructions. Machine learning system 410 may provide prompt 535 to transformer model 436. Transformer model 436 may apply in-context learning to infer an instruction based on demonstrations 567. For example, transformer model 436 may infer, based on pairs of sample statements 562 and respective paraphrases 584 included in demonstrations 567, the task of generating a paraphrased statement for input statement 552. Transformer model 436 may infer, based on pairs of sample statements 562 and respective paraphrases 584 included in demonstrations 567, a pattern of a type of paraphrased statement to generate for input statement 552. In this way, transformer model 436 may transform input statement 552 to a paraphrased statement similar to how paraphrases 584 transformed respective sample statements 562 in demonstrations 567.

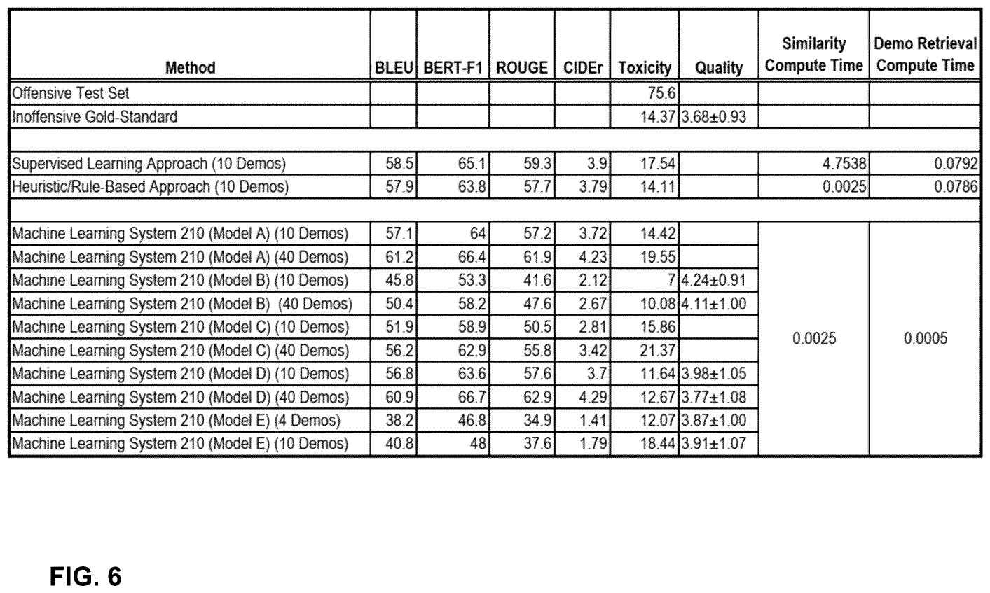

FIG. 6 is a table illustrating an example evaluation of in-context learning performance, in accordance with techniques of this disclosure. FIG. 6 may be discussed with respect to FIG. 2 for example purposes only.

In the example of FIG. 6, prompt evaluator 239 may evaluate the performance of various in-context learning approaches based on different scoring or metrics techniques (e.g., BLEU, BERT-F1, ROUGE, CIDEr, Toxicity, Quality, etc.) and inference compute time (e.g., similarity compute time, demo retrieval compute time, etc.). For example, prompt evaluator 239 may determine scores according to the different scoring techniques for sample statements of reference data 222 (e.g., sample statements of an APPDIA dataset, a ParaDetox dataset, a CAPP dataset, etc.) that are labeled as offensive and/or inoffensive. Prompt evaluator 239 may partition sample statements of reference data 222 into an offensive test set and an inoffensive gold-standard test set. Prompt evaluator 239 may determine the toxicity of the offensive test set and the inoffensive gold-standard test set to establish a baseline for toxicity values in terms of what is an offensive toxicity value and an inoffensive toxicity value. In the example of FIG. 6, prompt evaluator 239 may determine a toxicity value of around 75.6 may be offensive and a toxicity value of around 14.37 may be inoffensive.

Prompt evaluator 239 may determine scores and inference runtime for conventional techniques of supervised learning approaches and heuristic or rule-based approaches. In the example of FIG. 6, prompt evaluator 239 may determine that supervised learning approaches has comparable score values as the heuristic or rule-based approach when selecting ten demonstrations (e.g., ten sample statements and corresponding ground-truth information). Prompt evaluator 239 may determine that the similarity compute time and the demo retrieval compute time for supervised learning approaches is longer than corresponding compute times for heuristic or rule-based approaches.

Prompt evaluator 239 may determine scores and inference runtimes for machine learning system 210. Prompt evaluator 239 may determine scores and inference runtimes for machine learning system 210 performing in-context learning using different types of models of transformer model 236 and selecting a different number of demonstrations using the different types of models. For example, prompt evaluator 239 may determine scores and inference runtimes for machine learning system 210 selecting 4, 10, or 40 demonstrations to generate a prompt for models A-E. Models A-E may represent different machine learning models of transformer model 236 such as MMR-BERT, GPT-3.5-Turbo, Text-Davinci, Vicuna, or the like.

As can be seen in FIG. 6, prompt evaluator 239 may determine that machine learning system 210 may output paraphrased statements with scores that are comparable to corresponding scores for the supervised learning approach and the heuristic or rule-based approach. Prompt evaluator 239 may determine that the inference run-time of embedding extractor 216 determining similarity scores is faster than supervised learning approaches and comparable to heuristic or rule-based approaches. Prompt evaluator 239 may determine that the inference run-time of demonstrations selector 218 selecting demonstrations based on computed similarity scores is faster than both supervised learning approaches and heuristic or rule-based approaches. By machine learning system 210 storing sample embeddings at sample embeddings 242 prior to the inference phase of processing an input statement and selecting demonstrations based on similarity scores, machine learning system 210 may significantly reduce the compute time it takes to retrieve demonstrations after similarity score are computed, while maintaining performance of in-context learning tasks. Thus, machine learning system 210, according to the techniques described herein, may improve computational resource utilization (e.g., fewer memory and processing resources used) to generate prompts for in-context learning tasks given a limited volume of sample statements.

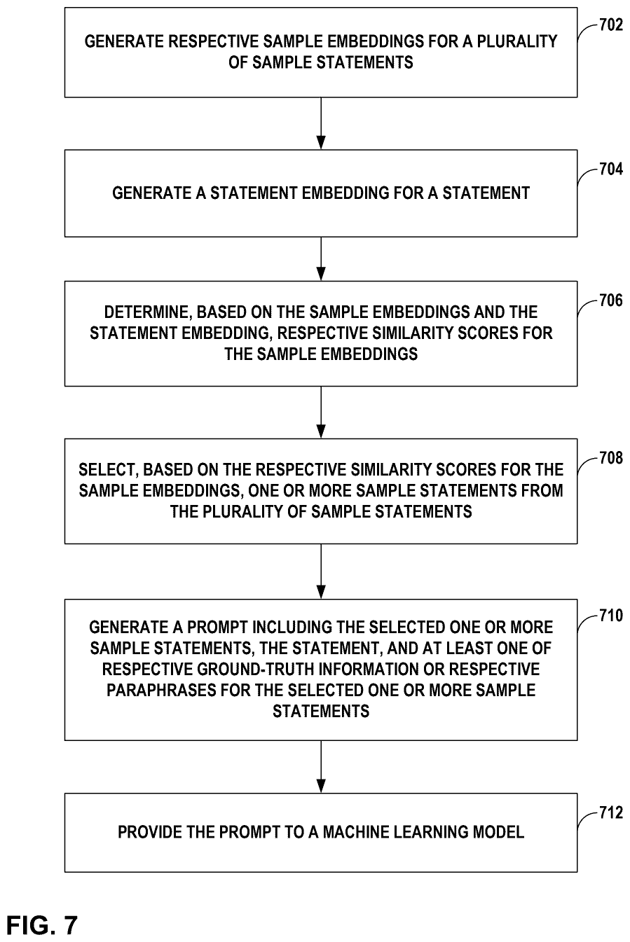

FIG. 7 is a flowchart illustrating an example mode of operation for generating prompts for in-context learning, in accordance with techniques of this disclosure. FIG. 7 may be discussed with respect to FIG. 1 for example purposes only.

Computing system 100 may generate respective sample embeddings for a plurality of sample statements (702). Computing system 100 may generate a sample embedding as a high-dimensional vector embedding that captures or characterizes contextual information of a corresponding sample statement in a high dimensional vector or embedding space. Computing system 100 may generate a statement embedding for statement 152 (704). Computing system 100 may generate the statement embedding for statement 152 as a high-dimensional vector embedding that captures or characterizes contextual information of statement 152 in the high dimensional vector or embedding space.

Computing system 100 may determine, based on the sample embeddings and the statement embedding, respective similarity scores for the sample embeddings (706). For example, computing system 100 may determine the respective similarity score for the sample embeddings by computing cosine similarity scores between the statement embedding and each of the sample embeddings. Computing system 100 may select, based on the respective similarity scores for the sample embeddings, one or more sample statements from the plurality of sample statements (708). For example, computing system 100 may order, based on the respective similarity scores for the sample embeddings, the plurality of sample statements. Computing system 100 may select, based on the ordering of the plurality of sample statements, the one or more sample statements from the plurality of sample statements. For instance, computing system 100 may select a specified number of sample statements that are ordered as having the highest similarity score and/or select a number of sample statements based on a similarity score threshold (e.g., select N-number of sample statements that satisfy a threshold).

Computing system 100 may generate a prompt including the selected one or more sample statements, the statement, and at least one of respective ground-truth information or respective paraphrases for the selected one or more sample statements (710). For example, in instances where computing system 100 is tasked to classify statement 152, computing system 100 may generate a prompt to include the selected one or more sample statements, statement 152, and respective ground-truth information associated with the selected one or more sample statements that is stored at reference data 122. In instances where computing system 100 is tasked to paraphrase statement 152, computing system 100 may generate a prompt to include the selected one or more sample statements, statement 152, and respective paraphrases for the selected one or more sample statements that are stored at reference data 122. In some instances (e.g., in instances where computing system implements a paraphrase trigger after classifying statement 152), computing system 100 may generate a prompt that include the selected one or more sample statements, statement 152, respective ground-truth information associated with the one or more selected sample statements, and respective paraphrases for the one or more selected sample statements. In some examples, computing system 100 may generate the prompt to include an instruction specifying a task associated with the respective ground-truth information (e.g., “classify according to classification labels,” “paraphrase,” etc.).

Computing system 100 may provide the prompt to machine learning model 136 (712). In instances where the respective ground-truth information includes one or more respective classification labels of a plurality of classification labels for the one or more selected sample statements, computing system 100 may obtain, from machine learning model 136, a response to the prompt as an indication of a classification label of the plurality of classification labels. Computing system 100 may output, to computing device 150, the indication of the classification label. In some examples, in instances where the prompt is a first prompt including the selected one or more sample statements, the statement, and the respective ground-truth information, computing system 100 may generate, based on a determination that the classification label is associated with a paraphrase trigger, a second prompt to include the selected one or more sample statements, the statement, and the respective paraphrases for the selected one or more sample statements. Computing system 100 may provide the second prompt to machine learning model 136. Computing system 100 may obtain, from machine learning model 136, a paraphrased statement. Computing system 100 may output, to computing device 150, the paraphrased statement.

In instances where the prompt includes the selected one or more sample statements, the statement, and the respective paraphrases for the selected one or more sample statements, computing system 100 may obtain, from machine learning model 136, a response to the prompt as a paraphrased statement. Computing system 100 may output, to computing device 150, the paraphrased statement. In some instances, where the respective paraphrases are in a first language, computing system 100 may obtain statement 152 as a target statement in a second language. Computing system 100 may translate statement 152 to the first language before generating the statement embedding or before selecting the demonstrations. Computing system 100 may provide the prompt generated in the first language to machine learning model 136. Computing system 100 may obtain, from machine learning model 136, a paraphrased statement in the first language. Computing system 100 may translate the paraphrased statement in the first language to the second language before outputting the paraphrased statement to computing device 150 and/or an intended recipient of statement 152.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in computer-readable media, such as a computer-readable storage medium, containing instructions. Instructions embedded or encoded in one or more computer-readable storage mediums may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A method comprising:
generating, by a computing system, respective sample embeddings for a plurality of sample statements;
generating, by the computing system, a statement embedding for a statement;
determining, by the computing system, based on the sample embeddings and the statement embedding, respective similarity scores for the sample embeddings;
selecting, by the computing system, based on the respective similarity scores for the sample embeddings, one or more sample statements from the plurality of sample statements;
generating, by the computing system, a prompt including the selected one or more sample statements, the statement, and at least one of respective ground-truth information or respective paraphrases for the selected one or more sample statements; and
providing, by the computing system, the prompt to a machine learning model.

2. The method of claim 1, wherein the respective ground-truth information includes one or more respective classification labels of a plurality of classification labels for the one or more sample statements, and wherein the method further comprises:
obtaining, from the machine learning model, a response to the prompt as an indication of a classification label of the plurality of classification labels; and
outputting, to a user device, the indication of the classification label.

3. The method of claim 2, wherein the prompt is a first prompt including the selected one or more sample statements, the statement, and the respective ground-truth information, and wherein the method further comprises:
generating, based on a determination that the classification label is associated with a paraphrase trigger, a second prompt to include the selected one or more sample statements, the statement, and the respective paraphrases for the selected one or more sample statements;
providing the second prompt to the machine learning model;
obtaining, from the machine learning model, a paraphrased statement; and
outputting, to the user device, the paraphrased statement.

4. The method of claim 1, wherein the prompt includes the selected one or more sample statements, the statement, and the respective paraphrases for the selected one or more sample statements, and wherein the method further comprises:
obtaining, from the machine learning model, a response to the prompt as a paraphrased statement; and
outputting, to a user device, the paraphrased statement.

5. The method of claim 4, wherein the respective paraphrases and the paraphrased statement are associated with a first language, and wherein the statement is associated with a second language, and wherein the method further comprises:
translating the statement to the first language; and
translating the paraphrased statement to the second language.

6. The method of claim 1, wherein determining the respective similarity scores for the sample embeddings comprises: computing cosine similarity scores between the statement embedding and each of the sample embeddings.

7. The method of claim 1, wherein selecting the one or more sample statements from the plurality of sample statements comprises:
ordering, based on the respective similarity scores for the sample embeddings and without rules or heuristics associated with diversity or complexity of the plurality of sample statements, the plurality of sample statements; and
selecting, based on the ordering of the plurality of sample statements, the one or more sample statements from the plurality of sample statements.

8. The method of claim 1, wherein the prompt includes an instruction specifying a task associated with the respective ground-truth information.

9. The method of claim 1, further comprising:
obtaining the plurality of sample statements;
assigning a classification label to each sample statement of the plurality of sample statements, wherein the plurality of sample statements include dialogue-style statements;
generating respective sample paraphrases for a set of sample statements of the plurality of sample statements; and
generating reference data to include the plurality of sample statements, each classification label for the plurality of sample statements, and the respective sample paraphrases for the set of sample statements,
wherein generating the respective sample embeddings for the plurality of sample statements comprises retrieving the plurality of sample statements from the reference data and storing the respective sample embeddings;
wherein selecting the one or more sample statements comprises retrieving the one or more sample statements from the reference data, and
wherein generating the prompt includes retrieving the respective paraphrases from the reference data as one or more sample paraphrases of the sample paraphrases associated with the selected one or more sample statements, the selected one or more sample statements included in the set of sample statements.

10. The method of claim 1, wherein the machine learning model is a transformer model.

11. A computing system comprising processing circuitry and memory for executing a machine learning system, the machine learning system configured to:
generate respective sample embeddings for a plurality of sample statements;
generate a statement embedding for a statement;
determine, based on the sample embeddings and the statement embedding, respective similarity scores for the sample embeddings;
select, based on the respective similarity scores for the sample embeddings, one or more sample statements from the plurality of sample statements;
generate a prompt including the selected one or more sample statements, the statement, and at least one of respective ground-truth information or respective paraphrases for the selected one or more sample statements; and
provide the prompt to a machine learning model.

12. The computing system of claim 11, wherein the respective ground-truth information includes one or more respective classification labels of a plurality of classification labels for the one or more sample statements, and wherein the machine learning system is further configured to:
obtain, from the machine learning model, a response to the prompt as an indication of a classification label of the plurality of classification labels; and
output, to a user device, the indication of the classification label.

13. The computing system of claim 12, wherein the prompt is a first prompt including the selected one or more sample statements, the statement, and the respective ground-truth information, and wherein the machine learning system is further configured to:
generate, based on a determination that the classification label is associated with a paraphrase trigger, a second prompt to include the selected one or more sample statements, the statement, and the respective paraphrases for the selected one or more sample statements;
provide the second prompt to the machine learning model;
obtain, from the machine learning model, a paraphrased statement; and
output, to the user device, the paraphrased statement.

14. The computing system of claim 11, wherein the prompt includes the selected one or more sample statements, the statement, and the respective paraphrases for the selected one or more sample statements, and wherein the machine learning system is further configured to:
obtain, from the machine learning model, a response to the prompt as a paraphrased statement; and
output, to a user device, the paraphrased statement.

15. The computing system of claim 11, wherein to select the one or more sample statements from the plurality of sample statements, the machine learning system is configured to:
order, based on the respective similarity scores for the sample embeddings and without rules or heuristics associated with diversity or complexity of the plurality of sample statements, the plurality of sample statements; and
select, based on the ordering of the plurality of sample statement, the one or more sample statements from the plurality of sample statements.

16. The computing system of claim 11, wherein the machine learning system is further configured to:
obtain the plurality of sample statements;
assign a classification label to each sample statement of the plurality of sample statements, wherein the plurality of sample statements include dialogue-style statements;
generate respective sample paraphrases for a set of sample statements of the plurality of sample statements; and
generate reference data to include the plurality of sample statements, each classification label for the plurality of sample statements, and the respective sample paraphrases for the set of sample statements,
wherein to generate the respective sample embeddings for the plurality of sample statements, the machine learning system is configured to retrieve the plurality of sample statements from the reference data and store the respective sample embeddings;
wherein to select the one or more sample statements, the machine learning system is configured to retrieve the one or more sample statements from the reference data, and
wherein to generate the prompt, the machine learning system is configured to retrieve the respective paraphrases from the reference data as one or more sample paraphrases of the samples paraphrases associated with the selected one or more sample statements, the selected one or more sample statements included in the set of sample statements.

17. Computer-readable storage media comprising machine readable instructions for configuring a computing system to:
generate respective sample embeddings for a plurality of sample statements;
generate a statement embedding for a statement;
determine, based on the sample embeddings and the statement embedding, respective similarity scores for the sample embeddings;
select, based on the respective similarity scores for the sample embeddings, one or more sample statements from the plurality of sample statements;
generate a prompt including the selected one or more sample statements, the statement, and at least one of respective ground-truth information or respective paraphrases for the selected one or more sample statements; and
provide the prompt to a machine learning model.

18. The computer-readable storage media of claim 17, wherein the respective ground-truth information includes one or more respective classification labels of a plurality of classification labels for the one or more sample statements, and wherein the machine readable instructions further configure the computing system to:
obtain, from the machine learning model, a response to the prompt as an indication of a classification label of the plurality of classification labels; and
output, to a user device, the indication of the classification label.

19. The computer-readable storage media of claim 17, wherein the prompt includes the selected one or more sample statements, the statement, and the respective paraphrases for the selected one or more sample statements, and wherein the machine readable instructions further configure the computing system to:
obtain, from the machine learning model, a response to the prompt as a paraphrased statement; and
output, to a user device, the paraphrased statement.

20. The computer-readable storage media of claim 17, wherein to select the one or more sample statements from the plurality of sample statements, the machine readable instructions configure the computing system to:
order, based on the respective similarity scores for the sample embeddings and without rules or heuristics associated with diversity or complexity of the plurality of sample statements, the plurality of sample statements; and
select, based on the ordering of the plurality of sample statement, the one or more sample statements from the plurality of sample statements.
